(19) United States
(12) Patent Application Publication
(10) Pub. No.: US 2013/0054662 A1
(43) Pub. Date: Feb. 28, 2013

(54) METHODS OF USING GENERALIZED ORDER DIFFERENTIATION AND INTEGRATION OF INPUT VARIABLES TO FORECAST TRENDS

(71) Applicant: Carlos F. M. Coimbra, Merced, CA (US)

(72) Inventor: Carlos F. M. Coimbra, Merced, CA (US)

(73) Assignee: The Regents of the University of California, Oakland, CA (US)

(21) Appl. No.: 13/641,083

(22) PCT Filed: Apr. 12, 2011
(86) PCT No.: PCT/US11/32151

§ 371 Date: Nov. 7, 2012

Related U.S. Application Data
(60) Provisional application No. 61/323,501, filed on Apr. 13, 2010.

(51) Int. Cl. G06F 7/38

(52) U.S. Cl. 708/230

(57) ABSTRACT

Disclosed are methods and apparatuses to generate a forecast based on generalized differentiation or integration, including but not limited to non-integer or variable order differentiation or integration.

### CROSS-REFERENCE TO RELATED PATENT APPLICATIONS

This application claims the benefit under 35 U.S.C. §119(e) of U.S. Provisional Application No. 61/323,501, filed on Apr. 13, 2010, the contents of which are hereby incorporated by reference in their entirety into the present disclosure.

### FIELD OF THE DISCLOSURE

The present disclosure generally relates to methods of generating a forecast using generalized order differentiation and integration, including non-integer and/or variable order differentiation and integration, of input variables.

### BACKGROUND

Forecasting is the process of making statements about events or objects whose actual outcomes have not yet been observed, can not be observed, or have been blinded for various reasons. Various methods, such as artificial neural networks and genetic algorithms, have been developed to generate forecasts based on observed or available information in the form of, for instance, input data sets. The input data can be used directly by such methods, or can be transformed. The transformation can take place on individual data points or on a set of data collectively. Examples of transformation include differentiation or integration.

A well researched forecasting method is artificial neural networks. Artificial neural networks are systems that function in a manner similar to that of the human nerve system. Like the human nerve system, the elementary elements of an artificial neural network include the neurons, the connections between the neurons, and the topology of the network. Artificial neural networks learn and remember in ways similar to the human process and thus show great promise in forecasting tasks such as weather and stock market forecasting which are difficult for conventional computers and data-processing systems.

The performance of forecasting, on the other hand, also depends on the amount and quality of input data. Therefore, there is a need in developing new methods of extracting and transforming available input data to make accurate forecasting.

One exemplary area where accurate forecasting can play an important role is forecasting of solar farm output. One of the critical challenges in transitioning to an energy economy based on renewable resources is to overcome issues of intermittence, capacity and reliability of non-dispatchable energy sources such as solar, wind or tidal. The intermittent nature of these resources implies substantial challenges for the current modus operandi of power producers, utility companies and independent service operators (ISOs), especially when high market penetration rates (such as the ones now mandated by law in California and other US states) are considered.

Although solar energy is clearly the most abundant power resource available to modern societies, the implementation of widespread solar power utilization is so far impeded by its sensitivity to local weather conditions, intra-hour variability, and dawn and dusk ramping rates. In particular, the direct sunlight, which is critical for concentrating solar technologies, is much less predictable than the global irradiance, which includes the diffuse component from the sky hemisphere. If the power grid were to depend on a large amount of energy coming from the solar resource each day, then a power drop due to cloud cover could adversely affect local grid stability, with possible domino effects throughout the extended power grid.

### SUMMARY OF THE DISCLOSURE

It has been discovered herein that, compared to existing methods, forecasting utilizing non-integer or variable order differentiation or integration of input variables showed significantly improved performance.

For example, non-integer or variable order differentiation or integration can be used in data pre-processing. Such a pre-processing step is useful on at least two aspects: first, non-integer or variable order differentiation or integration can generate non-local representations of a limited number of input variables. In this sense, the non-integer—usually called ‘fractional’—derivatives are non-local operators carrying information about the history of the function, as opposed to integer order operators that only carry local information. Second, the use of non-integer derivatives allows one to seek the fractal dimension of the most relevant input variables. This fractal dimension is directly identifiable by a single number, that is the noninteger order of the derivative selected, and thus condenses a great deal of information about the nature of the time series in a format that is easy to optimize.

Accordingly, one aspect of the disclosure provides a method for generating a forecast in a custom computing apparatus comprising at least one processor and a memory, the method comprising:

receiving, in the memory, a plurality of data points of a measurement;

accessing, by the at least one processor the plurality of data points;

calculating, by the at least one processor, a forecast for the measurement with a mathematical method using one or more differentiation or integration of the plurality of data points as inputs, wherein at least one of the one or more differentiation or integration is a non-integer or variable order differentiation or integration.

Also provided is a custom computing apparatus comprising:

at least one processor;

a memory coupled to the at least one processor;

a storage medium in communication with the memory and the at least one processor, the storage medium containing a set of processor executable instructions that, when executed by the processor configure the custom computing apparatus to generate a forecast, comprising a configuration to:

receive, in the memory, a plurality of data points of a measurement;

access, by the at least one processor the plurality of data points; and

calculate, by the at least one processor, a forecast for the measurement with a mathematical method using one or more differentiation or integration of the plurality of data points as inputs, wherein at least one of the one or more differentiation or integration is a non-integer or variable order differentiation or integration.

The methods and custom computing apparatuses of the disclosure are suitable for generating forecasts, including but not limited to, weather forecast, gaming forecast, stock market forecast, solar or wind power prediction, biological behavior prediction, social behavior prediction, earthquake prediction, epidemiological prediction and medical diagnosis or prognosis.

### BRIEF DESCRIPTION OF THE DRAWINGS

FIG. 1A-B compare the performance of a forecasting method of the disclosure to an existing method employing divided differences of inputs. A. Dispersion plot of forecasted versus measured values where the forecast used divided differences. B. Dispersion plot of forecasted versus measured values where the forecast was based a single non-integer derivative of the input variable. The model in B performed much better than the one in A, as evidenced by the large number of data points falling on the x or y axis in A. The root mean square error for the method in B was halved when compared with the divided differences simulation in this simple example.

FIG. 2A-B demonstrate the performance of a method that employs a single non-integer order derivative of the input variable with real data for solar irradiance. A. Measured (squares) and forecasted (circles) values for direct normal irradiance (DNI) for a clear day in Merced, Calif. B. Same comparison, but for a cloudy day in the same location. The method captured most variations of irradiance accurately, even when atmospheric conditions include complex factors such as tole fog.

FIG. 3A compares the root mean square errors (RMSE) for a persistent (no-memory) method and a method using multiple non-integer derivatives of orders varying from zero to unity. The error in forecasting solar irradiance in this case was substantially smaller for the method using multiple non-integer derivatives of orders, particularly when data were scarce (small jmax) than the persistent method.

FIG. 3B shows the same comparison as FIG. 3A but based on R². It was, again, observed that that the method using multiple non-integer derivatives of orders outperformed the persistent model for all values of data interval collection.

FIG. 4 shows an exemplary computer system suitable for use with the present disclosure.

FIG. 5 presents hourly averaged Power Output (PO) from November 2009 to May 2010.

FIG. 6 shows data set used for the ANNs performance evaluation.

FIG. 7 is a schematic representation of the ENIO methodology. The genome specifies: which inputs are preprocessed and how; and which inputs are used in the ANN. Statistical metrics (RMSE and standard deviations) are used to determine the fitness of each ANN. The GA is advanced based on the selection, crossover and mutation operators.

FIG. 8 illustrates all the input combinations for the 1-hour ahead forecasts using baseline (BASE) inputs as in Table 1. The solid gray line represents the Pareto front. The insert display the inputs in Table 1 used in the Pareto front ANNs.

FIG. 9 shows all the input combinations for the 2-hour ahead forecasts using baseline (BASE) inputs as in Table 1. The solid gray line represents the Pareto front. The insert display the inputs in Table 1 used in the Pareto front ANNs.

FIG. 10 are Scatter plot for the 1-hour ahead forecasts (left) and 2-hours ahead forecasts (right) without baseline (BASE) preprocessing.

FIG. 11 indicates comparison between 1-hour ahead forecast and measured values of Power Output (PO) using baseline (BASE) inputs.

FIG. 12 indicates Comparison between 2-hours ahead forecast and measured values of Power Output (PO) using baseline (BASE) inputs.

FIG. 13 shows all the individuals of the last generation for the 1-hour ahead forecasts with Non-Integer Order (ENIO) preprocessing. The solid gray line represents the Pareto front. The insert display the inputs used in the Pareto front ANNs as well as the non-integer orders of PO used in the preprocessing stage.

FIG. 14 shows All the individuals of the last generation for the 2-hours ahead forecasts with Non-Integer Order (ENIO) preprocessing. The solid gray line represents the Pareto front. The insert display the inputs used in the Pareto front ANNs as well as the non-integer orders of PO used in the preprocessing stage.

FIG. 15 are scatter plot for the 1-hour ahead forecasts (left) and 2-hours ahead forecasts (right) using ENIO preprocessing.

FIG. 16 presents comparison between 1-hour ahead forecast and measured values of Power Output (PO) using ENIO preprocessing.

FIG. 17 presents comparison between 2-hours ahead forecast and measured values of Power Output (PO) using ENIO preprocessing.

### DETAILED DESCRIPTION OF THE DISCLOSURE

Throughout this disclosure, various publications, patents and published patent specifications are referenced by an identifying citation. The disclosures of these publications, patents and published patent specifications are hereby incorporated by reference in their entirety into the present disclosure.

As used herein, certain terms have the following defined meanings Terms that are not defined have their art recognized meanings

As used in the specification and claims, the singular form “a”, “an” and “the” include plural references unless the context clearly dictates otherwise.

As used herein, the term “comprising” is intended to mean that the compositions and methods include the recited elements, but not excluding others. “Consisting essentially of” when used to define compositions and methods, shall mean excluding other elements that would materially affect the basic and novel characteristics of the claimed invention. “Consisting of” shall mean excluding any element, step, or ingredient not specified in the claim. Embodiments defined by each of these transition terms are within the scope of this disclosure.

A “measurement” or “variable” intends any quantifiable information of an event or an object. Non-limiting examples include temperature, humidity, wind speed and direction, stock price, weight and concentration of a biological or chemical substance, frequency of earthquake, prevalence of a disease in a certain population, and likelihood of response of a patient to a medical treatment.

An “artificial neural network” or simply a “neural network” is a device or a simulated device that implements a mathematical model or computational model that tries to simulate the structure and/or functional aspects of biological neural networks. An artificial neural network consists of an interconnected group of artificial neurons and processes information using a connectionist approach to computation. In most cases an artificial neural network is an adaptive system that changes its structure based on external or internal information that flows through the network during the learning phase.

A “genetic algorithm” is a search technique used in computing to find exact or approximate solutions to optimization and search problems. Genetic algorithms are categorized as global search heuristics. Genetic algorithms are a particular class of evolutionary algorithms (EA) that use techniques inspired by evolutionary biology such as inheritance, mutation, selection, and crossover. A detailed explanation of the genetic algorithm is available in Holland (1992) “Adaptation in Natural and Artificial Systems: An Introductory Analysis with Applications to Biology, Control, and Artificial Intelligence,” the MIT Press.

A “Turing machine” intends a machine learning approaches initially developed by Alan Turing in 1937. A detailed description of the method is described in Jack Copeland ed. (2004), The Essential Turing: Seminal Writings in Computing, Logic, Philosophy, Artificial Intelligence, and Artificial Life plus The Secrets of Enigma, Clarendon Press (Oxford University Press), Oxford UK.

An “artificial immune system” refers to computational systems inspired by the principles and processes of the vertebrate immune system. A detailed description of artificial immune systems can be found in de Castro and Timmis (2002) Artificial Immune Systems: A New Computational Intelligence Approach. Springer. pp. 57-58.

A “hidden Markov model” is a statistical model in which the system being modeled is assumed to be a Markov process with unobserved state. A detailed description of the hidden Markov model can be found in Rabiner (1989) “A tutorial on Hidden Markov Models and selected applications in speech recognition”. Proceedings of the IEEE 77(2): 257-286.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

### MODES FOR CARRYING OUT THE TECHNOLOGY

The methods and apparatuses of the disclosure are based on the discovery that forecasting using different streams of functional behavior as inputs can greatly improve the forecasting performance when the streams of functional behavior are calculated by taking generalized derivatives or integrations.

“Generalized derivatives or integrals”, “generalized order derivatives or integrals”, or “generalized differintegral” as used herein, refers to derivatives or integrals not just in the order of an integer or a static number. The term “differintegral” is based on the generalization of differentiation and integration because, in essence, a negative order differentiation is actually integration and vice versa. In one aspect, a generalized derivative or integral includes a non-integer derivative or integral. In another aspect, a generalized derivative or integral includes a variable order derivative or integral, which can be a restricted variable order derivative or integral or a generalized variable derivative or integral.

A “restricted variable order derivative or integral” refers to a variable order differentiation/integration operator restricted to orders smaller than 1, and is defined in Equation (I):

$${D}^{q ( t )} x ( t ) = \frac{1}{Γ ( 1 - q ( t ) )} {\int }_{0 +}^{t} {( t - σ )}^{- q ( t )} {D}^{1} x ( σ ) d σ + \frac{( x ( 0 + ) - x ( 0 - ) ) {t}^{- q ( t )}}{Γ ( 1 - q ( t ) )} \qquad ( I )$$

wherein q(t) is the order of differentiation (note that q can be a function of both the dependent variable x(t) and of the independent variable t), x(t) is a given function, operator D¹ represents the first derivative operator, and F is the Gamma function.

A “generalized variable order derivative or integral”, by contrast, is not restricted to orders smaller than 1, and is defined in Equation (II):

$${D}^{q ( t )} x ( t ) = \frac{1}{Γ ( n - q ( t ) )} {\int }_{0 +}^{t} {( t - σ )}^{n - 1 - q ( t )} {D}^{n} x ( σ ) d σ + {\sum }_{i = 0}^{n - 1} \frac{( {D}^{n} x ( 0 + ) - {D}^{n} x ( 0 - ) ) {t}^{i - q ( t )}}{Γ ( i + 1 - q ( t ) )} \qquad ( II )$$

wherein q(t) is the order of differentiation (note that q can be a function of both the dependent variable x(t) and of the independent variable t), x(t) is a given function, the differential operator Dⁿ x(t) stands for the n-derivative of the function x(t) and Γ is the Gamma function.

Compared to positive and zeroth orders of derivatives and integrals that are local in nature, each non-integer order carries history information of the independent variable. Variable orders, both in the restricted form and in the general form, involve the past behavior of the independent variable as well. Therefore, forecasting making use of the generalized differentiation or integration allow for better characterization of multiple scales of forecast.

The following equations illustrate non-integer order derivatives:

$$sY ( s ) -> {y}^{′} ( t ) + y ( 0 )$$

$${s}^{2} Y ( s ) -> {y}^{n} ( t ) + {y}^{′} ( 0 ) + sy ( 0 )$$

$${s}^{1 / 2} Y ( s ) = \frac{sY ( s )}{{s}^{1 / 2}} = G ( s ) * F ( s ) -> {\int }_{0}^{t} {y}^{′} \frac{d σ}{\sqrt{π ( t - σ )}} + \frac{y ( 0 )}{\sqrt{π t}}$$

Physically, the first derivative of displacement is velocity, and the zero derivative is the displacement itself. The half derivative is the quantity that is dynamically equivalent to the intermediate behavior in time between displacement and velocity. For example, the Basset force in Fluid Mechanics is proportional to the half derivative of the relative velocity between the particle and the fluid.

For example, consider the simple process of forecasting the temperature variation in time of a controlled environment, and assume that the best indicator of future temperature variation is the temperature itself as a function of time. In this simple example, the past temperature is the input variable and the future temperature is the desired forecast. Current forecasting procedures would use the temperature itself (order zero of differentiation) and, say, the first and second order derivatives of temperature in time as input streams. Therefore, a stochastic forecasting methodology would consist of three different input streams (the zeroth, the first and the second order of derivatives of temperature in respect to time) for one forecast output (the temperature in a given point in time in the future). The three streams of input are fed to a stochastic model, for example, an artificial neural network, which “learns” to predict the future behavior of temperature based on these inputs.

In accordance with methods and apparatuses of the present disclosure, however, at least a non-integer or variable order of derivative or integral of temperature can be used as inputs. Each non-integer order carries history information of the independent variable (temperature) since only positive orders (including the zeroth order) are local. All other orders involve the past behavior of the independent variable (temperature), and therefore allow for better characterization of multiple scales of forecast. In the simple example above, one can use the −2.4, −1.2, −0.4, 0.5, 0.6, 0.9, and 3-order differintegrals of temperature as input streams.

Accordingly, one aspect of the present disclosure provides a method for generating a forecast measurement in a custom computing apparatus comprising at least one processor and a memory, the method comprising:

receiving, in the memory, a plurality of data points of a measurement;

accessing, by the at least one processor the plurality of data points;

calculating, by the at least one processor, a forecast for the measurement or a measurement derived from or relevant to the measurement with a mathematical method using one or more differentiation or integration of the plurality of data points as inputs, wherein at least one of the one or more differentiation or integration is a non-integer or variable order differentiation or integration.

Also provided is a custom computing apparatus comprising:

at least one processor;

a memory coupled to the at least one processor;

a storage medium in communication with the memory and the at least one processor, the storage medium containing a set of processor executable instructions that, when executed by the processor configure the custom computing apparatus to generate a forecast, comprising a configuration to:

receive, in the memory, a plurality of data points of the measurement;

access, by the at least one processor the plurality of data points; and

calculate, by the at least one processor, a forecast for the measurement or a measurement derived from or relevant to the measurement with a mathematical method using one or more differentiation or integration of the plurality of data points as inputs, wherein at least one of the one or more differentiation or integration is a non-integer or variable order differentiation or integration.

Data points of one measurement may be used alone or in combination with data points of other measurement to generate a forecast for a different measurement. For example, past temperature may be used in combination with other information to generate a forecast for past or future humidity. As used herein, a first measurement being derived from or relevant to a second measurement intents that the first measurement has a correlation with the second measurement such that a forecast for the first measurement can be determined based on observations of the second measurement alone or in combination with other observations.

In one aspect, at least one of the one or more differentiation or integration is a non-integer (n) differentiation or integration, with n being less than 0, or alternatively less than 1, or alternatively between 0 and 1, or alternatively greater than 1, or alternatively great then 2, or 3, or 4, or 5. In another aspect, at least one of the one or more differentiation or integration is a variable order differentiation or integration. In some embodiment, the variable order differentiation or integration is restricted variable order differentiation or integration. In some embodiments, the differentiation or integration is generalized differentiation or integration.

In some embodiments, the methods or apparatuses of the present disclosure further comprises displaying the forecast in a suitable format on a screen or on a printing device. Examples of suitable formats includes, without limitation, charts, curves, tables or images.

Mathematical models suitable for the methods and apparatuses of the present disclosure include various statistical, probability or stochastic models. A common forecasting model is artificial neural network. Also commonly used forecasting models include Turing machine, genetic algorithm, artificial immune system, and hidden Markov model, all of which are described supra.

The methods and apparatuses of the present disclosure can be used for any forecasting. In one aspect, the forecast is a time-dependent forecast and the plurality of data points comprise historic data points. In another aspect, the forecast is a prediction of unmeasured data points and the plurality of data points comprise measured data points. For examples, the methods and custom computing apparatuses of the disclosure are suitable for generating forecasts, including but not limited to, weather forecast, gaming forecast, stock market forecast, solar or wind power prediction, biological behavior prediction, social behavior prediction, earthquake prediction, epidemiological prediction and medical diagnosis or prognosis. In some aspects, the methods further include a taking the measurement, or the apparatuses further include a component for taking the measurement.

In some embodiments, in any of the methods or apparatuses of the present disclosure, the plurality of data points comprise data points from at least one type of measurement. In some embodiments, the plurality of data points comprise data points from at least two types of measurements. For example, whether forecast may depend on past temperature as well as humidity, each of which measurements provide data points for the forecasting.

For purpose of illustration, to predict the behavior of the function g(t), in which f(t) and h(t) are determined to be good indicators of the behavior of g(t), the generalized differintegral operator to all three functions, f(t), g(t) and h(t) can be applied using one or several optimized orders qᵢ(t). The generalized operator of order q(t) applied to x(t) is:

$${D}^{q ( t )} x ( t ) = \frac{1}{Γ ( n - q ( t ) )} {\int }_{0 +}^{t} {( t - σ )}^{n - 1 - q ( t )} {D}^{n} x ( σ ) d σ + {\sum }_{i = 0}^{n - 1} \frac{( {D}^{n} x ( 0 + ) - {D}^{n} x ( 0 - ) ) {t}^{i - q ( t )}}{Γ ( i + 1 - q ( t ) )} \qquad ( II )$$

which is valid for q(t)<n, and n can be arbitrarily set as long as x(t) is differentiable to order n.

Equation (II) is a nontrivial generalization of Equation (I). The orders qᵢ(t) are determined by an additional optimization method, e.g., genetic algorithm, artificial neural network, and can be expressed as a continuous function oft or x(t), or even f(t), g(t) or h(t), or it can be a number of discrete (integer or noninteger) values q1, q2, q3, etc. In one aspect, qᵢ(t) is expressed as a summation of factors a_{n,i}t^{n,i}, and optimize the factor a_{n,i} using a genetic algorithm. This methodology yields substantially better forecasting models, as illustrated in the examples below.

### Computer Systems

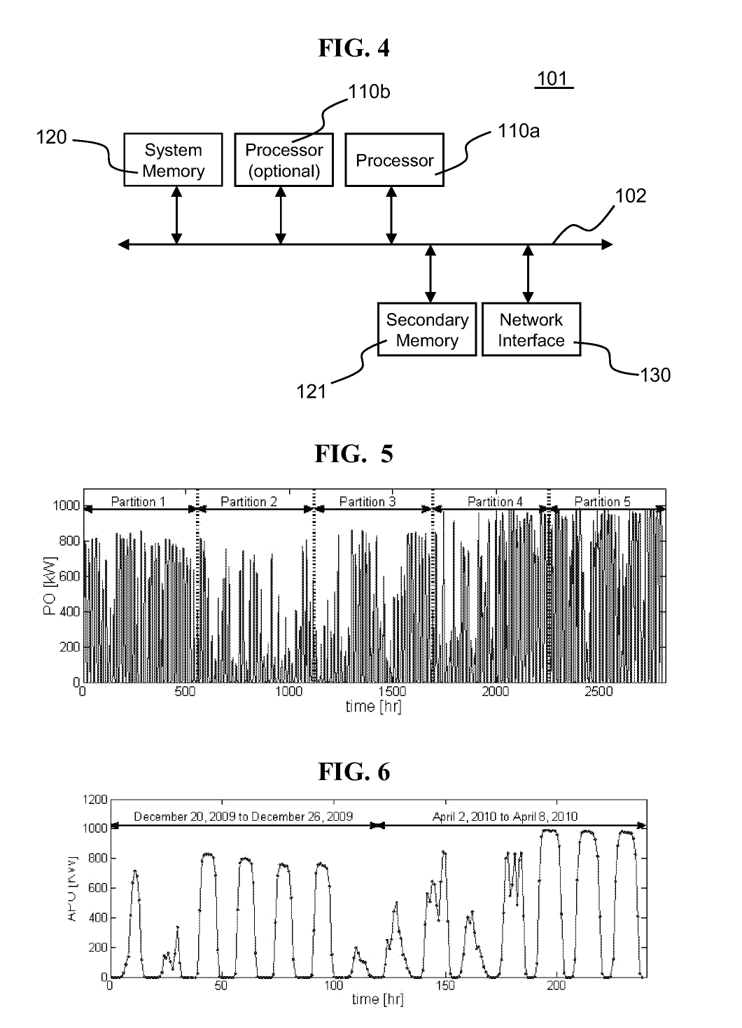

FIG. 4 illustrates an example of a computational system 101 on which the forecasting methods or apparatuses can be implemented. The computer system 101 can include one or more processor(s) 110a or 110b. Processor(s) 110 are connected to a transmission infrastructure 102, such as an internal bus or network. The computer system 101 also includes system memory (or random access memory (RAM)) 120, and can include a secondary memory 121. Secondary memory 121 can include a hard disk drive (not illustrated) and/or a removable storage drive (not illustrated), such as a magnetic tape drive, an optical disk drive, etc. The removable storage drive can read from and/or write to a removable storage medium/computer readable storage medium, such as magnetic tape, optical disk, magneto-optical disk, removable memory chip (or card), or any other storage medium that allows software and/or data to be loaded into computer system 101 via the removable storage drive. The computer system 101 shown in FIG. 4 can further include one or more network interfaces 130 that allow software and/or data to be transferred between computer system 101 and external devices (not shown). Examples of network interfaces 130 include modems, Ethernet cards, etc.

Like processor(s) 110, system memory 120, secondary memory 121, and network interface 130 each also connect to transmission infrastructure 102. The use of transmission infrastructure 102 allows software and/or data transmission among processor(s) 110, system memory 120, secondary memory 121, and network interface 130. Software and/or data transmitted via transmission infrastructure 102 or network interface 130 can be in the form of signals such as electronic signals, electromagnetic signals, optical signals, or any other form that facilitates the transmission of data.

Any suitable programming language can be used to implement the software routines or modules that can be used with embodiments of the present disclosure. Such programming languages can include C, C++, Java, assembly language, etc. Procedural and object oriented programming techniques can also be used with the present disclosure. The software routines or modules can be stored in system memory 120 and/or secondary memory 121 for execution by one or more processor(s) 110 to implement embodiments of the present disclosure.

As known to persons of ordinary skill in the art, computer systems having configurations or architectures other than that illustrated in FIG. 4 can be used with embodiments of the present disclosure. For example, a standalone computer system need not include network interface 130, and so on.

The following examples are provided to illustrate certain aspects of the present disclosure and to aid those of skill in the art in practicing the disclosure. These examples are in no way to be considered to limit the scope of the disclosure.

### Example 1

The data set used in this example includes a single variable (DNI), with several gaps in the data set, which normally makes it very difficult to train an Artificial Neural Network. The figure plots forecasted versus actually measured values. The plot in the left employs divided differences inputs while the right plot employs a single Non-Integer Order of Differentiation method.

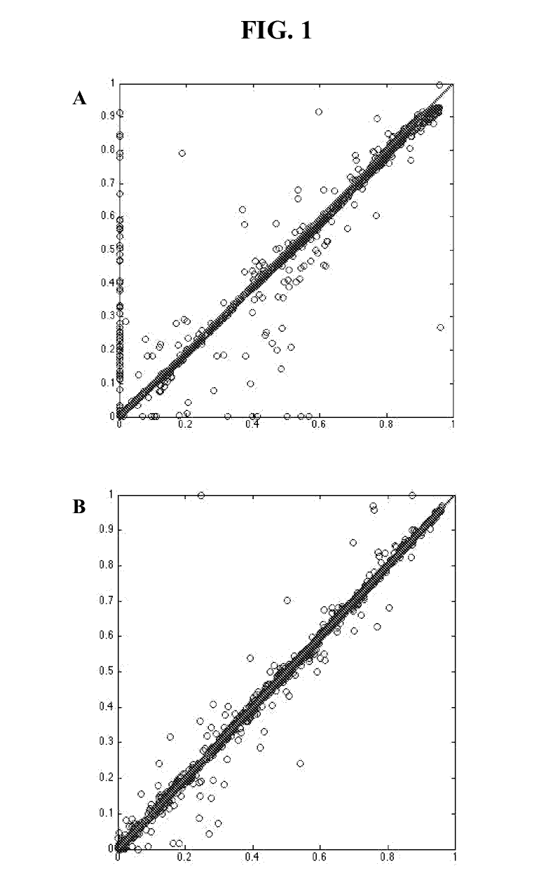

FIG. 1A-B compare the performance of a forecasting method of the disclosure to an existing method employing divided differences of inputs. A. Dispersion plot of forecasted versus measured values where the forecast used divided differences. B. Dispersion plot of forecasted versus measured values where the forecast was based a single non-integer derivative of the input variable. The model in B performed much better than the one in A, as evidenced by the large number of data points falling on the x or y axis in A. The root mean square error for the method in B was halved when compared with the divided differences simulation in this simple example.

### Example 2

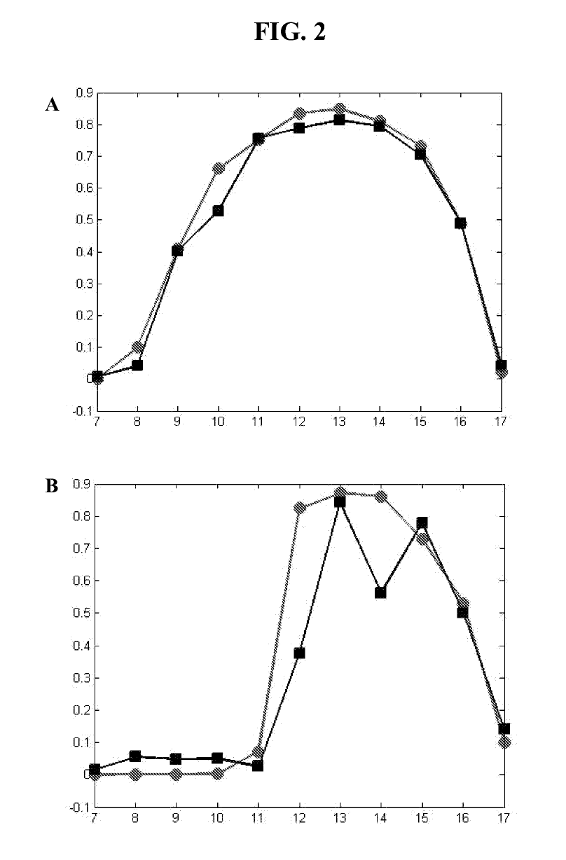

The methodology of the present disclosure was also tested against real data for solar irradiance, and the results of the memory-intensive computations show how accurate the forecasting models can be when compared with data for the direct normal irradiance in Merced, Calif. FIG. 2 shows a simple implementation of the model. The dark curves are measured values, whereas the light curves are forecasted.

FIG. 2A-B demonstrate the performance of a method that employs a single non-integer order derivative of the input variable with real data for solar irradiance. A. Measured (squares) and forecasted (circles) values for direct normal irradiance (DNI) for a clear day in Merced, Calif. B. Same comparison, but for a cloudy day in the same location. The method captured most variations of irradiance accurately, even when atmospheric conditions include complex factors such as tule fog.

### Example 3

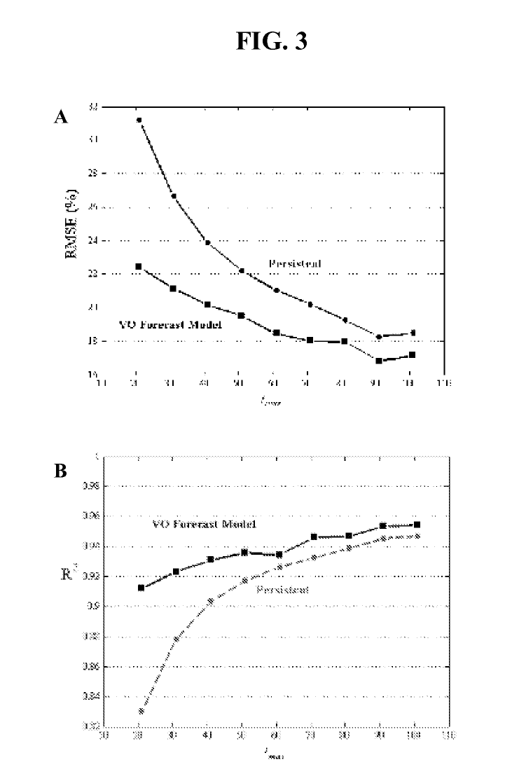

As shown in FIGS. 3A and 3B, in Example 3, FIG. 3A compares the root mean square errors (RMSE) for a persistent (no-memory) method and a method using multiple non-integer derivatives of orders varying from zero to unity. The error in forecasting solar irradiance in this case was substantially smaller for the method using multiple non-integer derivatives of orders, particularly when data were scarce (small jmax) than the persistent method.

FIG. 3B shows the same comparison as FIG. 3A but based on R². It was, again, observed that that the method using multiple non-integer derivatives of orders outperformed the persistent model for all values of data interval collection.

### Example 4

This example demonstrates that evolutionary non-integer order method yields accurate forecast of solar farm output.

Here, an Evolutionary Non-Integer Order (ENIO) method was used to improve the accuracy of a forecasting model for solar power output from a 1 MW solar farm. The ENIO method consists of a Genetic Algorithm (GA) overseeing the evolutionary development of Artificial Neural Networks (ANNs) through a multi-objective optimization algorithm. The figures of merit for the fitness test are the Root Mean Square Error (RMSE) between predicted and forecasted power output, and the variance of the RMSE. The ENIO method is completed with the implementation of a non-integer order filter that preprocesses the set of time series used as input variables. Thus, the input variable streams consist of the current power output (PO) and several fractional order derivatives of PO, plus irradiance data collected onsite. Substantial improvements on the quality of 1 and 2 hours ahead forecasts are reported when compared with other integer order deterministic and stochastic forecasting techniques.

### Data

The data used in this work corresponded to the performance of a single-axis tracking, polycrystalline photovoltaic, 1 MW peak solar power plant located in Central California (Merced). This solar farm provides about 20% of the power consumed yearly by the University of California, Merced campus, and was used as test-bed for solar forecasting and demand response studies. The time period analyzed spanned from November 2009 to May 2010 corresponding to the worst solar meteorology conditions for solar power production and forecasting due to increased levels of cloud cover in the winter months.

This example selected this period to emphasize the ability of the methodology to forecast difficult conditions (the irradiance during the summer months in California's Central Valley are much more easily predictable). The data points collected from the power plant site corresponded to the hourly average of Power Output (PO), hourly average of Global Horizontal Irradiance (GHI), and hourly average temperature. Additional weather inputs, such as cloud cover, wind speed and direction were not considered in this study because the objective is to isolate the effects of non-integer order processing of the inputs.

Given that at night there is no power output, night values are removed from all data sets. FIG. 5 shows the PO for the period mentioned above.

### Data Partition

For the ANN implementation used here, the input data is split in to 3 different sets: training, validation and testing. As explained next, the forecasting ability of the ANNs depend upon the composition of each set (mostly training and validation sets), thus this example generated 10 different subsets of the available data for training, which were obtained from combinations of the 5 partitions shown in FIG. 5. For each of the 10 training sets 60% of the data (3 partitions) was used as the training set, and the remaining 40% (2 partitions) were split evenly as the validation set and testing set.

### Artificial Neural Network

Artificial Neural Networks are useful tools for problems in classification and regression and have been successfully employed in forecasting problems.

One of the advantages of ANNs is that no assumptions are necessary about the underlying process that relates input and output variables. In general, neural networks map the input variables x to the output y by sending signals through elements called neurons. Neurons are arranged in layers, where the first layer receives the input variables, the last produces the output and the layers in between, referred to as hidden layers, contain the hidden neurons. A neuron receives the weighted sum of the inputs Σₖ₌₁ⁿwⱼₖiₖ and produces the output oⱼ by applying the activation function ƒⱼ to the weighted sum. Inputs to a neuron could be from external stimuli or could be from output of the other neurons.

Once the ANN structure is established it undergoes a training process in which the weights wⱼₖ are adjusted so that the minimization of some performance function is achieved, typically the mean square error (MSE):

$$M S E = \frac{1}{M} {\sum }_{k = 1}^{M} {( {y}_{k} - {t}_{k} )}^{2} , \qquad [ 4.1 ]$$

where M is the number of samples for the training data and tₖ is the measured values or target. Numerical optimization algorithms such as back-propagation, conjugate gradients, quasi-Newton, and Levenberg-Marquardt have been developed to effectively adjust the weights.

A key factor for maximizing ANNs performance is the actual network structure (number of neurons, number of hidden layers, etc) as well as the choice of activation functions and, especially, the training method. This example focuses on separating the effect of using a non-integer order method of pre-processing the input variables so that it isolates the effectiveness of the processing methodology. Therefore this example fixes the following ANN settings, which were found to be near optimum in a previous publication (Marquez and Coimbra “Forecasting of global and direct solar irradiance using stochastic learning methods, ground experiments and the NWS database,” Solar Energy, 2011. in press, doi:10.1016/j.solerner.2011.01.007):
the ANN is a feed-forward network with 1 hidden layer with 20 neurons.
The activation function for the hidden layer is the hyperbolic tangent sigmoid transfer function and the activation function for the output layer is the linear transfer function.
The ANN is trained with the Levenberg-Marquardt backpropagation algorithm based on the MSE performance.

All functions and settings used in the present work are available in the Neural Network toolbox version 6.0 of MatLab.

Because ANNs are universal approximation functions, some problems such as overfitting (which leads to poor generalization for new data sets) can be common. There are several approaches to mitigate this problem including a detailed input sensitivity analysis, and the more recent use of Gamma tests for input selection. This example adopts a strategy in which each ANN is trained 10 times with different data sets in order to assess its generalization ability, a method that is somewhat akin to the ubiquitous committee of experts approach in ANN modeling.

### Non-Integer Order Pre-Processing

Fractional calculus (that is, calculus of integrals and derivatives of any arbitrary real or complex order) owes its origin to the question of whether the meaning of a derivative to an integer order could be extended to non-integer orders. This subject has gained considerable popularity and importance during the past decades, mainly to its ability to describe phenomena in diverse and widespread fields of science and engineering.

In this example the fractional calculus was used as a pre-processing tool for the input variables. This example used the simple property of discrete Fourier transforms in which the non-integer (of order q) derivative operator was transformed into a simple multiplicative factor:

[symbol]

{D^{q}f(t)}=(iw)^{q}\tilde{f}(w). [4.2]

Once the multiplication from equation 2 is carried out one can revert from the frequency domain by applying the inverse discrete Fourier transform. The GA then searches for the optimal non-integer order that provides the best input for the ANN computation, thus capturing the order of derivative of the power output (PO) that best functions as a relevant input.

### Methodology

Forecasting with Baseline (BASE) Inputs.

This example evaluates the effectiveness of fractional derivatives as a pre-processing tool for the inputs of ANNs. In order to have a consistent baseline for assessing the effect of fractional differentiation of the inputs, the forecasting was performed, in the first place, without taking fractional derivatives of the inputs. As mentioned above, the data measured on site consist in the hourly average values of power output, global horizontal irradiance and temperature. These three values at a given time t are the basic inputs for the forecasting of power output at the future time t+Δt, where Δt, the time horizon, is equal to 1 hour and 2 hours in this work. The input set is then augmented with previous values of PO, and with the first and second derivatives of PO at time t. In total 9 inputs are considered for the forecasting without fractional calculus. Table 1 lists the inputs for the baseline (BASE) case.

TABLE 1
Baseline inputs for the PO forecasting

| Number | Name | Variable |
|---|---|---|
| 1 | current GHI | GHI(t) |
| 2 | current PO | PO(t) |
| 3 | 1 hour before PO | PO(t − 1 hr) |
| . | . | . |
| . | . | . |
| . | . | . |
| 6 | 4 hour before PO | PO(t − 4 hr) |
| 7 | first derivative of PO | D¹ PO(t) |
| 8 | second derivative of PO | D² PO(t) |
| 9 | current average temperature | θ̅(t) |

Mathematically, assuming that all variables are used as inputs to the ANN, the forecasting model can be written as

P̂O(t+Δt)=f(GHI(t)+PO(t)+PO(t−1 hr)+ . . . +PO(t−4 hr)+D¹PO(t)+D²PO(t)+ θ̅(t). [4.3]

In addition to the factors pointed in section, the performance of the ANNs depend strongly in the input variables and there are several tools (for example normalization, principal component analysis and the Gamma test for input selection) to pre-process the input data to increase the forecasting performance. However, given that the goal was to demonstrate the usefulness of fractional calculus as a preprocessing tool, normalization was only applied to the input data. In the normalization process all the inputs were mapped into the interval [−1, 1] following a linear transformation. Given that, a priori, it is impossible to know which combination of inputs yields the best forecasting this example tested all possible combinations of input variables listed in Table 1. In total there are 2⁹−1=511 combinations for the input variables that originate 551 variations of the model equation 4.3.

The quality assessment for a particular set of forecast inputs is done by computing the root mean square error (RMSE) between the ANN predicted values of the power output (P̂O(t+Δt)) and the measured values (PO(t+Δt)),

$$R M S E = \sqrt{\frac{1}{n} {\sum }_{i = 1}^{n} {( PO - \hat{PO} )}^{2}} . \qquad [ 4.4 ]$$

Another important characteristic of a forecasting model is the capability of generalization, that is, the ability to maintain a good prediction capability when the input variable data are modified or augmented with new samples. To account for this factor this example adopted a strategy in which, for each of the 511 combinations of inputs 10 ANNs were created with different subsets of the data shown in FIG. 5 create as explained above. The 10 predictions were then compared to the measured values and the RMSE was calculated with equation 4.4. This way, for each input combination, this example had 10 values of RMSE and the quality of the forecasting was established with the mean of the RMSEs

$${μ}_{RMSE} = \frac{1}{10} {\sum }_{i = 1}^{10} ( R M S E ( i ) ) , \qquad [ 4.5 ]$$

and their standard deviation

$${σ}_{RMSE} = \sqrt{\frac{1}{9} {\sum }_{i = 1}^{10} {( R M S E ( i ) - {μ}_{RMSE} )}^{2}} . \qquad [ 4.6 ]$$

The best input combinations for forecasting are the ones that combine a small μRMSE with a small σRMSE.

To further emphasize the ability of the ANNs in forecasting generalized conditions, the data used for these calculations was not included in the training of the ANNs, and comprised 2 weeks of data that include clear sky days and overcast days. Those different sky cover conditions resulted in quite different power output profiles. The values used correspond to 7 days in December of 2009 and 7 days in April of 2010, and are shown in FIG. 6.

Forecasting with Non-Integer Order (ENIO) Inputs.

The second task was to repeat the forecast process using fractional calculus as a preprocessing tool for the inputs of the ANNs. Given that the objective was to predict the power output, and that power output was a strong indicator of future power output, this example applied the fractional derivatives method solely to this variable. Also, given that, there is no way to know, a priori, which order of the derivative is optimal for forecasting purposes, this example lets the GA select 5 optimal values of derivatives of the variable PO(t) in the range [−2, 2]. Note that the GA could select integer orders, but in all the simulations, this was not the case. The forecast model with ENIO inputs can be written as:

$$\hat{PO} ( t \vert + Δ t ) = f ( {w}_{1} GHI ( t ) + {w}_{2} PO ( t ) + {w}_{3} PO ( t - 1 hr ) + … + {w}_{6} PO ( t - 4 hr ) + {w}_{7} {D}^{1} PO ( t ) ++ {w}_{8} {D}^{2} PO ( t ) + {w}_{9} \overline{θ} ( t ) ++ {w}_{19} {D}^{q 1} PO ( t ) + … + {w}_{14} {D}^{q 5} PO ( t ) ) , \qquad [ 4.7 ]$$

where the weights wⱼε{0, 1}, j=1, . . . 14 determine the inclusion/exclusion of a given input variable in the model and qₖε[−2, 2], k=1, . . . 5 are the orders of the derivative D^{q}ₖ.

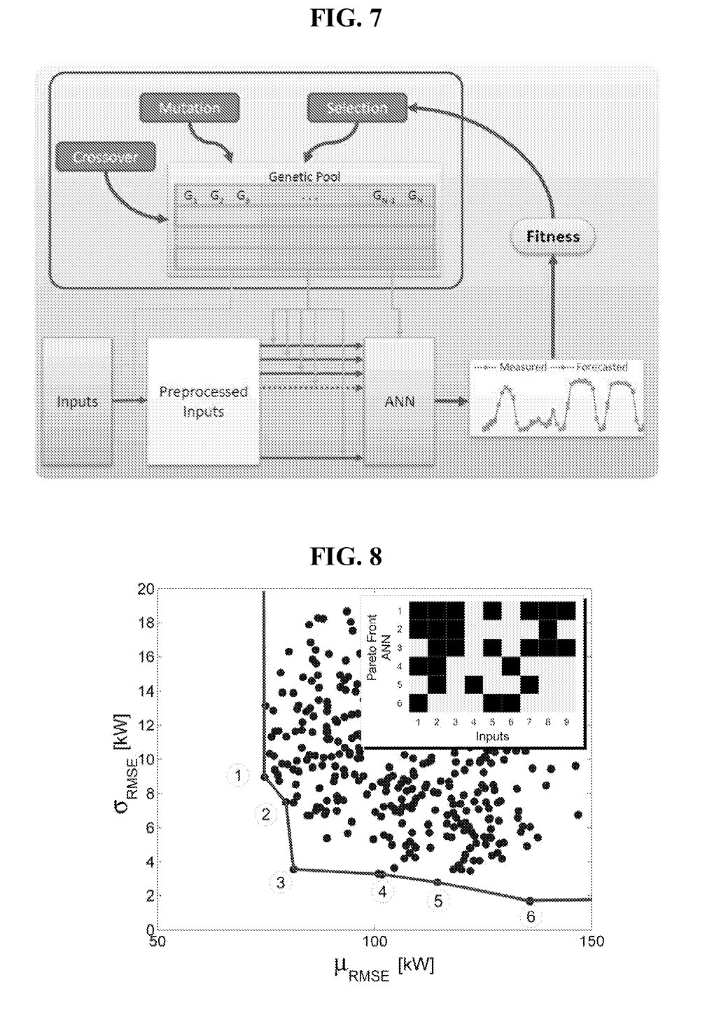

In order to determine which derivatives improve the forecasting this example implemented an optimization procedure using a GA. The goal of this optimization was twofold. In the first place, this example intended to find the order of the optimal orders of derivatives of PO(t) that yield the best forecasts; secondly, it wanted to find the best combination of input variables out of the 9 aforementioned ones augmented by the 5 new variables (the orders of derivatives of PO). In the following section the GA optimization algorithm is explained and FIG. 7 gives a schematic overview of the interaction between the GA and the ANNs.

Genetic Algorithm.

Genetic algorithms are biological metaphors that combine an artificial survival of the fittest with genetic operators abstracted from nature. In this solution space search technique, the evolution starts with a population of individuals, each of which carrying a genotypic and a phenotypic content. The genotype encodes the primitive parameters that determine an individual layout in the population. In this work the genotype consist in the weights wⱼj=1, . . . 14 and order of the fractional order derivative Dⁿₖ, k=1, . . . from equation 4.7. These 19 values are encoded as a vector of real numbers with the following structure
14 values ε[0, 1] that are later rounded to 0 or 1 and determine the weights wj;
5 values ε[−2, 2] that determine the order of the fractional order derivatives of PO, Dⁿₖ.

### Selection, Crossover and Mutation Operators

The initial population of 50 individuals was generated randomly with an uniform distribution and the algorithm proceeds to generate the following populations based on the selection, crossover and mutation operators. Mutated individuals accounted for 20% of a new population and the remaining are generated through crossover.

In the first place, the selection operator chose the parents for the following generation. Selection discovers the good features in the populations based on the fitness value of the individuals. The selection method used here was the tournament method, in which groups of 4 individuals were randomly selected to play a “tournament”, where the best fit was selected. The tournaments continued until a predetermined percentage of the population was selected as parents for crossover. This method was able to spread the genes associated to good features, while keeping a satisfactorily level of diversity in the population.

Crossover then proceeded to recombine the genetic material of the selected parents. Here the scattered method was used since it preserves the diversity of the population. In the scattered method, a random binary vector c with the same length of the genome, was used to select the genes coming from each parent. The crossover operator selected genes from the first parent where the vector c had 0 entry and selected genes from the second parent when c had 1 entry.

Mutation operates on the individuals that have not been selected for reproduction. To effect the mutation, a random number with a Gaussian distribution was added to each separate gene in the genome.

The Gaussian distribution had zero mean and a standard deviation that shrank as the number of generations increases. Mutation is essential to introduce genetic variability to the populations, specially when the population size is small.

### Stopping Criteria

It is usually difficult to formally specify a convergence criteria of the genetic algorithm because of its stochastic nature. In this work the algorithm stopped after 50 generations or if no improvement had been observed over a pre-specified number of generations, in this case 20, whichever was encountered first.

### Objective Function

Once the population for a new generation was determined, each individual in the population was evaluated. This was done through the objective or fitness function. Here, this example used exactly the same performance metrics as in the forecasting without fractional calculus, that is, the optimization sought to minimize both μRMSE and aRMSE, which turned the problem into a multi-objective optimization. The optimality of the individuals was defined with the most commonly adopted criterion of Pareto optimum. A Pareto optimum is a point where around it is not possible measurably improve some targets, without simultaneously worsening others. The set of non-dominated points is called the Pareto front.

### Results and Discussion

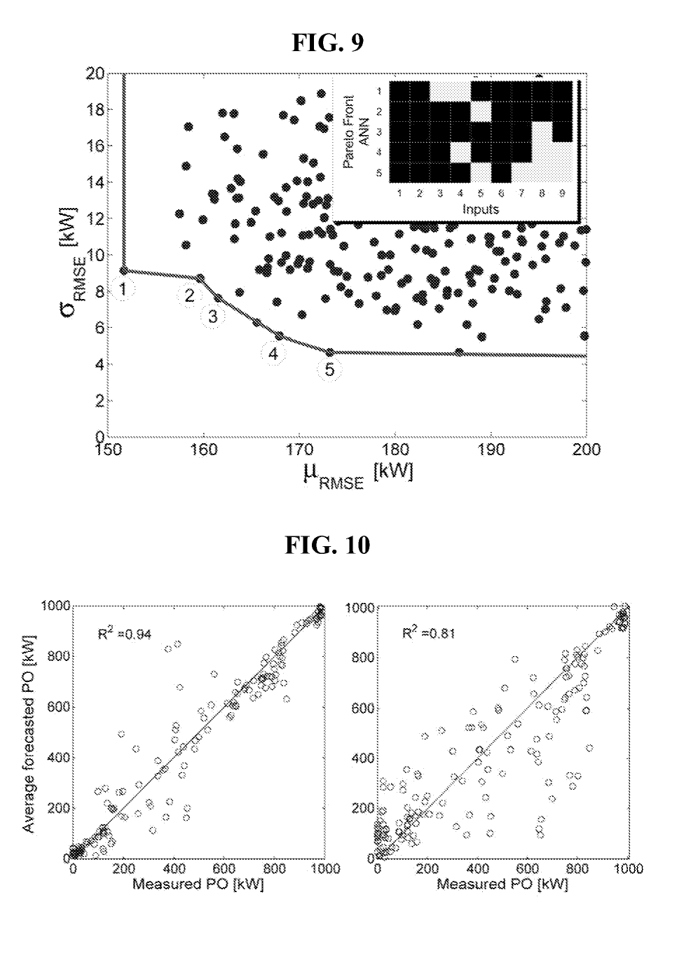

In order to study the influence of non-integer order pre-processing on the forecasting performance this example first built an integer-order baseline for comparison. Thus, first this example computed the 1- and 2-hours ahead forecasts using the inputs in Table 1. As explained before, 511 input combinations for the ANNs were studied and their μRMSE and σRMSE are plotted in FIG. 8 for the 1-hour ahead forecasts, and in FIG. 9 for the 2-hours ahead forecasts. The top performing ANNs were identified fowling the concept of Pareto optimality, and were graphically connected in the plots in order to create the Pareto front (shown in light gray). The insert in the figures indicates which inputs were used in the Pareto front ANNs. As expected, input number 2 in Table 1 (the current value of power output), was the most frequent one in all high-performing ANNs.

The analysis of both Pareto fronts reveals that for either 1- or 2-hours ahead forecasts, there are many ANNs that can achieve low GRMSE. The same was not true for μRMSE. For the 2-hour ahead forecasts, the minimum σRMSE obtained was roughly twice as large as for the 1-hour ahead forecasts, which was representative of the loss of information quality for larger time horizons. In order to further study the quality of the forecasting one ANN was selected from each Pareto front. The selection criterion was the proximity to the origin (0, 0). This criterion returns the ANN marked with 3 in FIG. 8 for the 1-hour ahead forecast, and the ANN marked with 1 in FIG. 9 for the 2-hours ahead forecast. The FIG. 10 shows the scatter plots that compare the fitting of the predicted PO to the measured PO, the correlation coefficient factor R² is also shown in the figure. Given that there were 10 prediction values for each ANN as explained above, this example used the average of these 10 values in the analysis.

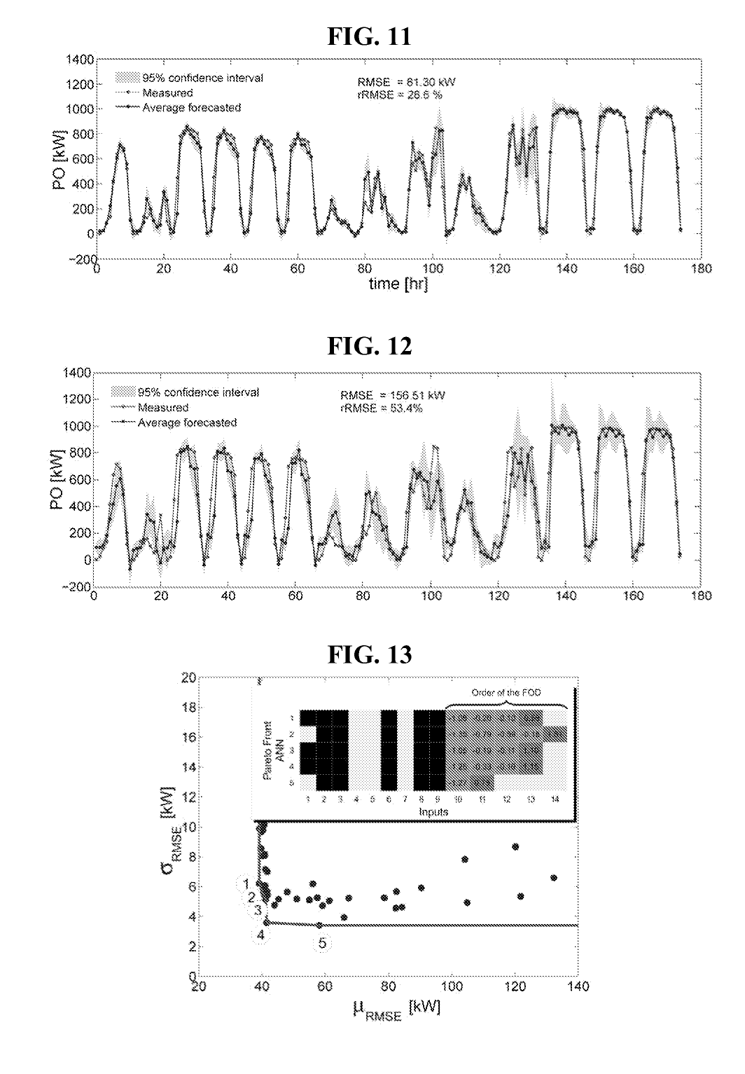

FIGS. 11 and 12 compare the averaged forecasted values for PO against the measured values. These figures also display the 95% confidence interval for the prediction. The confidence band was determined assuming that the 10 predicted values for any given time—P̂Oᵢ(t), i=1, . . . 10—follow a Student-t distribution with 9 degrees of freedom. The 95% confidence interval can then be computed by adding ±2.262 σ_{P̂O}_{ᵢ}₍ₜ₎ to the average predicted value, where the factor 2.262 is obtained form standard t-distribution tables. The figures show that the 1 hour ahead forecasts with baseline (BASE) inputs are in relative good agreement with the measured values (see, e.g, a comparison with results in Marquez and Coimbra “Forecasting of global and direct solar irradiance using stochastic learning methods, ground experiments and the NWS database,” Solar Energy, 2011. in press, doi:10.1016/j.solerner.2011.01.007). As expected the larger differences occurred in overcast days. As for the 2-hours ahead forecasts the differences are much larger. The REVISE for the fittings are also shown in the figure as well as the relative RMSE (rRMSE), which is obtained by dividing the RMSE by the Average Power Output (APO) for the entire period which is equal to 280.7 kW.

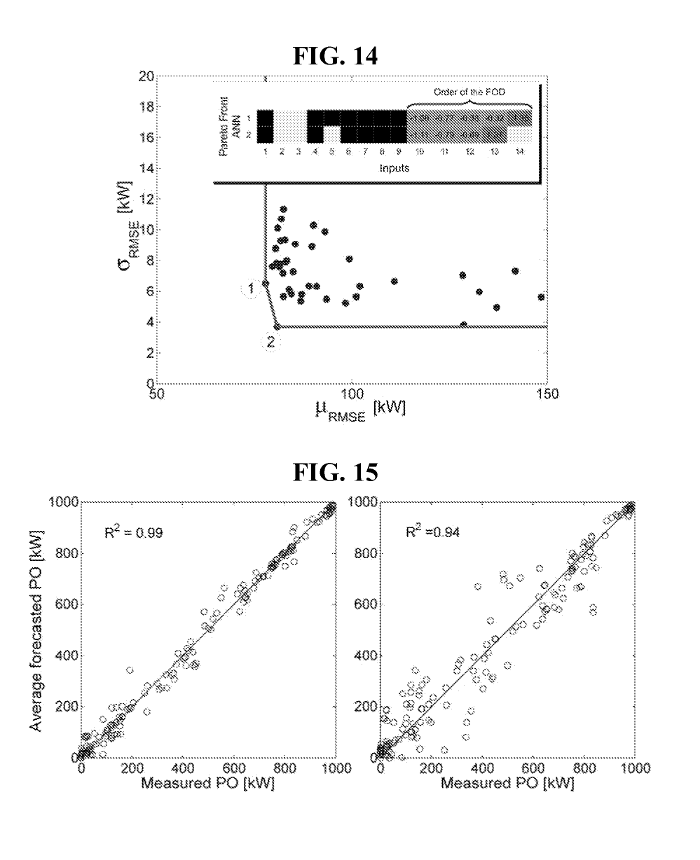

FIGS. 13 and 14 display the converged population for the genetic algorithm optimization. Again the fittest ANNs are form the Pareto front, and the inserts show the inputs used in the ANNs and the orders of differentiation of PO employed in the pre-processing stage. The comparison of these two figures against the correspondent ones for the baseline forecasts shows a remarkable improvement in minimization of μRMSE. With the ENIO pre-processing this example was able to decrease the μRMSE by a factor of 2 for the ANNs. The analysis of the inputs selected for the Pareto ANNs reveals that integration (negative orders) are more important than positive orders, possibly a reflection of the fact that the first and second derivatives were already available in the basic set of input variables (Table 1).

As for the baseline forecasts, this example selected one ANN from each Pareto front, in this case, the ones marked with 4 in FIGS. 13 and 2 in FIG. 14. The scattered plots that compare the fitting of the measured PO to the averaged predicted PO are shown in FIG. 15.

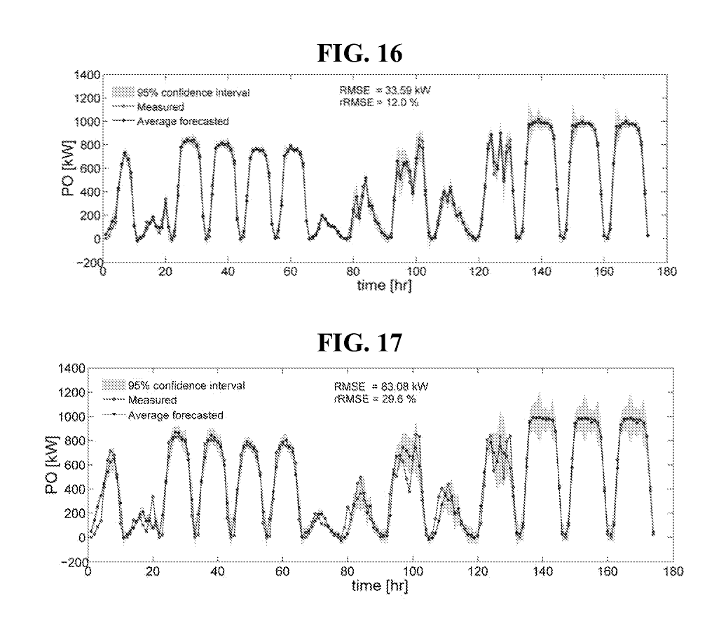

FIGS. 16 and 17 compare the measured PO time-series to the forecast PO time-series. The improvement with respect to the BASE forecast is clear. The 1-hour ahead forecasts show an almost perfect fit with very minor deviations for highly variable cloudy days. For the 2-hours ahead forecasts, the improvements are also very significant showing smaller decay of information quality over time. For cloudy days more discrepancies are observed for larger time horizons, but still much smaller than for the BASE forecasts (in fact, the 2-hour ahead deviations with ENIO are similar to the 1-hour ahead BASE forecasts).

This example demonstrates that non-integer order pre-processing of input data in the form of time series is effective in improving the short-term (1- and 2-hours ahead) forecast for power output of a photovoltaic solar farm. Accurate predictions for 1-hour ahead power output were obtained using the ENIO method, regardless of weather conditions. Substantial improvements were also obtained for the 2-hours ahead forecasts. The proposed technique effectively enable one to increase the forecast horizon form 1 hour to 2 hours without compromising prediction accuracy. Table 2 summarizes the performance statistics for the four cases studied. The pre-processing technique proposed here improves the correlation coefficient R² from 0.94 to 0.99 for the 1-hour ahead forecasts which indicates an almost perfect fit. For the 2-hours ahead forecasts the R² improves from 0.81 to 0.94. These are substantial improvements that were obtained for time horizons of great interest to power producers, utility companies and ISOs.

TABLE 2
Comparing ENIO and BASELINE forecasts

| Forecasting | RMSE [kW] | rRMSE[%] | R² |
|---|---|---|---|
| 1 hr. BASE | 81.30 | 28.6 | 0.94 |
| 1 hr. ENIO | 33.59 | 12.0 | 0.99 |
| 2 hr. BASE | 155.72 | 54.8 | 0.81 |
| 2 hr. ENIO | 83.08 | 29.6 | 0.94 |

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A method for generating a forecast in a custom computing apparatus comprising at least one processor and a memory, the method comprising:
receiving, in the memory, a plurality of data points of a measurement;
accessing, by the at least one processor the plurality of data points;
calculating, by the at least one processor, a forecast for the measurement with a mathematical method using one or more differentiation or integration of the plurality of data points as inputs, wherein at least one of the one or more differentiation or integration is a non-integer or variable order differentiation or integration.

2. The method of claim 1, further comprising displaying the forecast in a suitable format on a screen or on a printing device.

3. A custom computing apparatus comprising:
at least one processor;
a memory coupled to the at least one processor;
a storage medium in communication with the memory and the at least one processor, the storage medium containing a set of processor executable instructions that, when executed by the processor configure the custom computing apparatus to generate a forecast, comprising a configuration to:
receive, in the memory, a plurality of data points of a measurement;
access, by the at least one processor the plurality of data points; and
calculate, by the at least one processor, a forecast for the measurement with a mathematical method using one or more differentiation or integration of the plurality of data points as inputs, wherein at least one of the one or more differentiation or integration is a non-integer or variable order differentiation or integration.

4. The method of claim 1, wherein the mathematical method comprises a probability model.

5. The method of claim 1, wherein the mathematical method comprises a stochastic model.

6. The method of claim 1, wherein the mathematical method is one or more of an artificial neural network, a Turing machine, a genetic algorithm, an artificial immune system, or a hidden Markov model.

7. The method of claim 1, wherein the forecast is a time-dependent forecast and the plurality of data points comprise historic data points.

8. The method of claim 1, wherein the forecast is a prediction of unmeasured data points and the plurality of data points comprise measured data points.

9. The method of claim 1, wherein the forecast is selected from the group consisting of weather forecast, gaming forecast, stock market forecast, solar or wind power prediction, biological behavior prediction, social behavior prediction, earthquake prediction, epidemiological prediction and medical diagnosis or prognosis.

10. The method of claim 1, wherein at least one of the one or more differentiation or integration is an n-order differentiation or integration, wherein n is a non-integer.

11. The method or the computing apparatus of claim 10, wherein n is less than 1.

12. The method or the computing apparatus of claim 10, wherein n is greater than 1.

13. The method of claim 1, wherein at least one of the one or more differentiation or integration is a variable order differentiation or integration.

14. The method or the computing apparatus of claim 13, wherein the variable order differentiation or integration is a restricted form of variable order differentiation or integration.

15. The method or the computing apparatus of claim 14, wherein the restricted variable order differentiation or integration is determined by Equation I:
$${D}^{q ( t )} x ( t ) = \frac{1}{Γ ( 1 - q ( t ) )} {\int }_{0 +}^{t} {( t - σ )}^{- q ( t )} {D}^{1} x ( σ ) d σ + \frac{( x ( 0 + ) - x ( 0 - ) ) {t}^{- q ( t )}}{Γ ( 1 - q ( t ) )} \qquad ( I )$$
wherein:
x(t) is a function of measurement t;
q(t) is the order of differentiation;
operator D¹ denotes the first derivative operator; and
Γ is the Gamma function.

16. The method or the computing apparatus of claim 13, wherein the variable order differentiation or integration is a generalized variable order differentiation or integration.

17. The method or the computing apparatus of claim 16, wherein the generalized variable order differentiation or integration is determined by Equation II:
$${D}^{q ( t )} x ( t ) = \frac{1}{Γ ( n - q ( t ) )} {\int }_{0 +}^{t} {( t - σ )}^{n - 1 - q ( t )} {D}^{n} x ( σ ) d σ + {\sum }_{i = 0}^{n - 1} \frac{( {D}^{n} x ( 0 + ) - {D}^{n} x ( 0 - ) ) {t}^{i - q ( t )}}{Γ ( i + 1 - q ( t ) )} \qquad ( II )$$
wherein:
x(t) is a function of measurement t;
q(t) is the order of differentiation;
operator Dⁿ x(t) denotes the n-derivative of the function x(t); and
Γ is the Gamma function.

18. The method of claim 1, wherein the plurality of data points comprise data points from at least one type of measurement.

19. The method or the computing apparatus of claim 18, wherein the plurality of data points comprise data points from at least two types of measurements.
